(19) United States
(12) Patent Application Publication
(10) Pub. No.: US 2012/0183640 A1
(43) Pub. Date: Jul. 19, 2012

(54) INJECTION MOLD

(75) Inventors: WEN-PENG GONG, Dong-Guan (CN); Xiao-Ping Wu, Dong-Guan (CN); Kun-Hsueh Chiang, Tu-Cheng City (TW)

(73) Assignee: Cheng Uei Precision Industry Co., LTD., Tu-Cheng City (TW)

(21) Appl. No.: 13/007,440

(22) Filed: Jan. 14, 2011

(51) Int. Cl. B29C 45/33

(52) U.S. Cl. 425/577

(57) ABSTRACT

An injection mold includes a fixed mold having a clamping plate and a fixed plate mounted underneath the clamping plate. An angular pin has an upper end fastened in a through hole of the fixed plate and a lower end projected underneath the fixed plate. A side-compression block fastened underneath the fixed plate has a securing portion. A movable mold movably engaged with the fixed mold has a movable plate and a sliding plate slidably mounted on the movable plate and capable of sliding sideward on the movable plate under the actions of the lower end of the angular pin and the side-compression block. The sliding plate defines a guiding hole to receive the lower end of the angular pin therein when the injection mold is closed. A top surface of the movable plate defines a securing groove for securing the securing portion therein.

### BACKGROUND OF THE INVENTION

1. Field of the Invention

The present invention relates to an injection mold, and particularly to an injection mold with a side core-pulling mechanism.

2. The Related Art

A conventional injection mold includes a fixed mold and a movable mold engaged with the fixed mold. The movable mold has a sliding plate slidably mounted thereon. The fixed mold includes an angular pin slantwise fastened in the fixed mold and further projecting beyond a bottom of the fixed mold. When the injection mold is closed and opened, the angular pin can drive the sliding plate to slide sideward on the movable mold so as to achieve the side core-pulling function. Furthermore, the angular pin can also work as a fastening element acting on the sliding plate of the movable mold to prevent the sliding plate from sliding away from the initial position when the melting plastic is injected into the injection mold at the mold-closing position.

However, the force of the angular pin acting on the sliding plate is not powerful enough to prevent the sliding plate from sliding away from the initial position when the melting plastic is injected into the injection mold.

### SUMMARY OF THE INVENTION

Accordingly, an object of the present invention is to provide an injection mold. The injection mold includes a fixed mold having a clamping plate and a fixed plate mounted underneath the clamping plate. The fixed plate defines a through hole slantwise extending to penetrate through the fixed plate. An angular pin has an upper end fastened in the through hole of the fixed plate and a lower end projected underneath the fixed plate. A side-compression block is fastened underneath the fixed plate and spaced from the lower end of the angular pin. The side-compression block has a base body and a securing portion protruded downward from a bottom surface of the base body. A movable mold movably engaged with the fixed mold has a movable plate and a sliding plate slidably mounted on the movable plate and capable of sliding sideward on the movable plate under the actions of the lower end of the angular pin and the side-compression block. The sliding plate defines a guiding hole having a corresponding diameter to that of the lower end of the angular pin and slantwise extending to penetrate through a top of the sliding plate for being connected in alignment with the through hole to receive the lower end of the angular pin therein when the injection mold is closed. A top surface of the movable plate defines a securing groove for securing the securing portion of the side-compression block therein to make the base body resist against the sliding plate when the injection mold is at the mold-closing position.

As described above, the side-compression block has the securing portion secured in the securing groove of the movable plate to strengthen the locking forces between the fixed mold and the movable mold and further make the side-compression block firmly resist against the sliding plate, so that can avoid the sliding plate moving horizontally even though excessive injecting force acts on the sliding plate when the melting plastic is injected into the injection mold.

### BRIEF DESCRIPTION OF THE DRAWINGS

The present invention will be apparent to those skilled in the art by reading the following description thereof, with reference to the attached drawings, in which:

FIG. 1 is a partially cross-sectional view illustrating an injection mold at a mold-closing position in accordance with the present invention; and

FIG. 2 is a partially cross-sectional view illustrating the injection mold of FIG. 1 in an exploded state.

### DETAILED DESCRIPTION OF THE EMBODIMENT

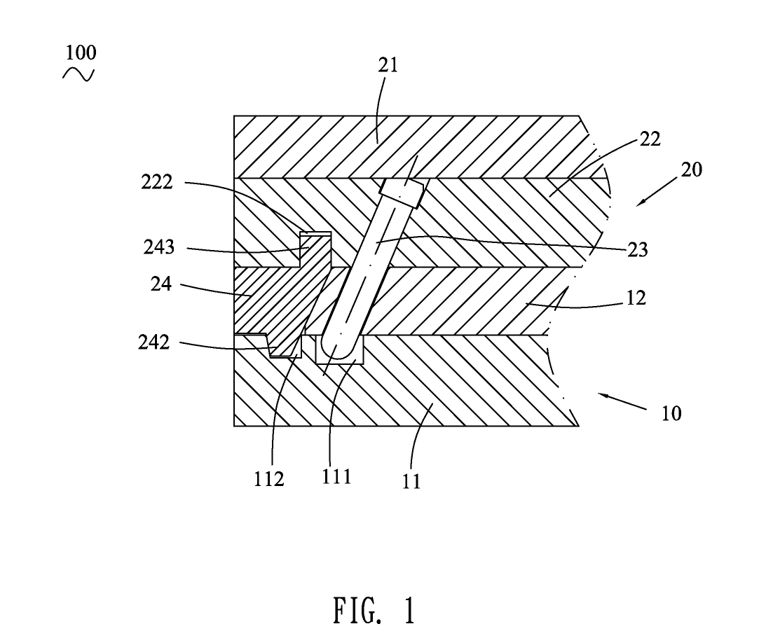

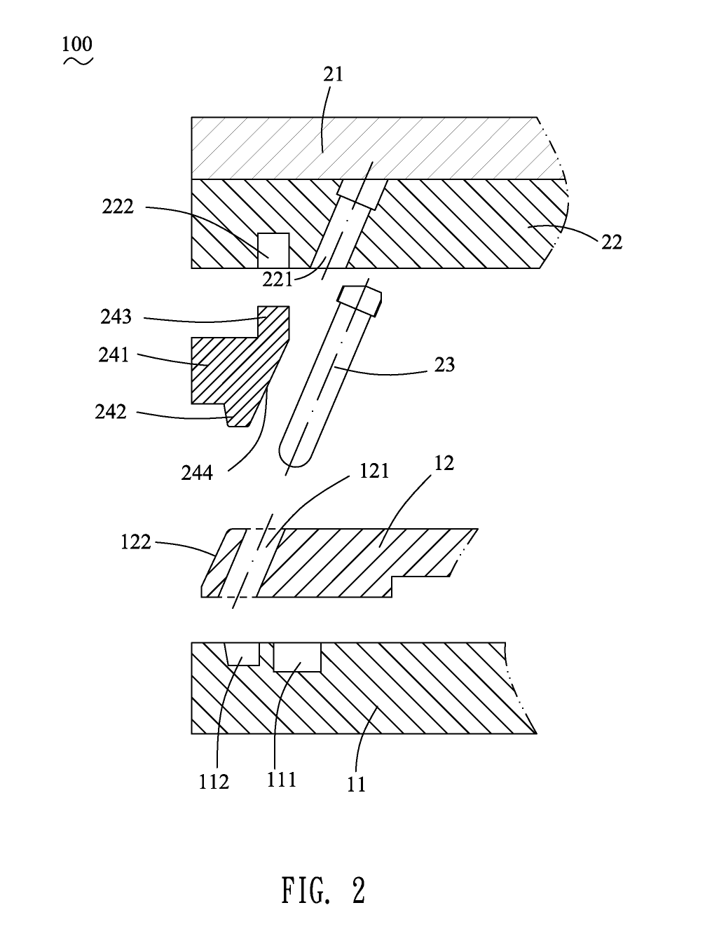

Referring to the drawings in greater detail, and first to FIGS. 1-2, the embodiment of the invention is embodied in an injection mold 100. The injection mold 100 comprises a fixed mold 20 and a movable mold 10 engaged with the fixed mold 20.

Refer to FIGS. 1-2 again. The fixed mold 20 has a clamping plate 21 fixed to a molding apparatus (not shown) and a fixed plate 22 mounted underneath the clamping plate 21. An angular pin 23 is slantwise mounted to the fixed plate 22 and further projects under the fixed plate 22. A side-compression block 24 is fastened underneath the fixed plate 22. The fixed plate 22 defines a fixing groove 222 at a bottom thereof and adjacent to a left side surface thereof, and a through hole 221 extending at an acute angle with respect to a vertical direction to penetrate through the fixed plate 22 and spaced from the fixing groove 222. In this embodiment, the distance between a lower opening of the through hole 221 and the left side surface of the fixed plate 22 is closer than the one between an upper opening of the through hole 221 and the left side surface of the fixed plate 22, and the fixing groove 222 is opened between the left side surface of the fixed plate 22 and the lower opening of the through hole 221. The side-compression block 24 has a base body 241 of trapezoid shape viewed from a front view, and a securing portion 242 protruded downward from a bottom surface of the base body 241. A side surface of the base body 241 is designed with an inclined surface having an acute angle with respect to the vertical direction, and the securing portion 242 also has an identical angle of inclined surface with the one of the base body 241. The two inclined surfaces of the base body 241 and the securing portion 242 are further coplanar with each other to define a side-compression surface 244 together. A top surface of the base body 241 protrudes upwards to form a fixing portion 243 which is adjacent to the side-compression surface 244.

The movable mold 10 movably engaged with the fixed mold 20 has a movable plate 11 and a sliding plate 12 slidably mounted on the movable plate 10. The sliding plate 12 defines a guiding hole 121 having a corresponding diameter to that of the through hole 221 of the fixed plate 22 and slantwise extending to penetrate through the sliding plate 12 for being connected in alignment with the through hole 221, when the injection mold 100 is closed. In this embodiment, the sliding plate 12 has a left side face designed as an inclined face 122 matching with the side-compression surface 244 of the base body 241 to make the sliding plate 12 slide on the movable plate 11 under the action of the side-compression surface 244 of the base body 241, in the process of the movable mold 10 moving towards the fixed mold 20. A top surface of the movable plate 11 defines a receiving groove 111 for receiving a distal end of the angular pin 23 therein, and a securing groove 112 opened between a left side surface of the movable plate 11 and the receiving groove 111 for securing the securing portion 242 of the side-compression block 24 therein, when the injection mold 100 is closed.

Refer to FIGS. 1-2. An upper end of the angular pin 23 is fastened in the through hole 221 of the fixed plate 22, and a lower end of the angular pin 23 passes through the through hole 221 to project underneath the fixed plate 22. The fixed plate 22 with the angular pin 23 is mounted underneath the clamping plate 21. The fixing portion 243 of the side-compression block 24 is fixed in the fixing groove 222 of the fixed plate 22 to make the base body 241 and the securing portion 242 locate under the fixed plate 22, with the side-compression surface 244 apart facing the lower end of the angular pin 23. In this embodiment, the inclined direction of the side-compression surface 244 is substantially parallel with an axis of the angular pin 23. The sliding plate 12 is slidably mounted on the movable plate 11.

In the process of the injection mold 100 being closed, the lower end of the angular pin 23 is inserted into the guiding hole 121 of the sliding plate 12 and the side-compression surface 244 of the side-compression block 24 is against the inclined face 122 of the sliding plate 12. Then the movable mold 10 keeps on moving towards the fixed mold 20, and the sliding plate 12 slides sideward on the movable plate 11 by means of the action of the side-compression surface 244 against the inclined face 122 and the cooperation between the lower end of the angular pin 23 and the guiding hole 121. When the injection mold 100 is completely closed, the distal end of the angular pin 23 is received in the receiving groove 111 of the movable plate 11. The securing portion 242 of the side-compression block 24 is secured in the securing groove 112 for strengthening the locking forces between the fixed mold 20 and the movable mold 10 and further making the side-compression block 24 firmly resist against the sliding plate 12 to prevent the movement of the sliding plate 12. In the process of separating the movable mold 10 from the fixed mold 20, the sliding plate 12 of the movable mold 10 slides sideward and downward along the side-compression surface 244 by means of the actions between the angular pin 23 and the guiding hole 121 of the sliding plate 12.

As described above, the side-compression block 24 has the securing portion 242 secured in the securing groove 112 of the movable plate 11 to strengthen the locking forces between the fixed mold 20 and the movable mold 10 and further make the side-compression block 24 firmly resist against the sliding plate 12, so that can avoid the sliding plate 12 moving horizontally even though excessive injecting force acts on the sliding plate 12 when the melting plastic is injected into the injection mold 100.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An injection mold, comprising:
a fixed mold having a clamping plate and a fixed plate mounted underneath the clamping plate, the fixed plate defining a through hole slantwise extending to penetrate through the fixed plate, an angular pin having an upper end fastened in the through hole of the fixed plate and a lower end projected underneath the fixed plate, a side-compression block being fastened underneath the fixed plate and spaced from the lower end of the angular pin, the side-compression block having a base body and a securing portion protruded downward from a bottom surface of the base body; and
a movable mold movably engaged with the fixed mold, the movable mold having a movable plate and a sliding plate slidably mounted on the movable plate and capable of sliding sideward on the movable plate under the actions of the lower end of the angular pin and the side-compression block, the sliding plate defining a guiding hole having a corresponding diameter to that of the lower end of the angular pin and slantwise extending to penetrate through a top of the sliding plate for being connected in alignment with the through hole to receive the lower end of the angular pin therein when the injection mold is closed, a top surface of the movable plate defining a securing groove for securing the securing portion of the side-compression block therein to make the base body resist against the sliding plate when the injection mold is at the mold-closing position.

2. The injection mold as claimed in claim 1, wherein the side-compression block is located between the angular pin and one side of the fixed plate and near to the one side of the fixed plate, a side surface of the base body facing the angular pin is designed with an inclined surface, the sliding plate has a side face designed as an inclined face matching with the inclined surface of the base body.

3. The injection mold as claimed in claim 2, wherein the inclined directions of the inclined surface of the base body and the inclined face of the sliding plate are substantially parallel with an axis of the angular pin.

4. The injection mold as claimed in claim 2, wherein the securing portion also has an identical angle of inclined surface with the one of the base body, the two inclined surfaces of the base body and the securing portion are further coplanar with each other to define a side-compression surface together for resisting against the inclined face of the sliding plate and guiding the slide of the sliding plate.

5. The injection mold as claimed in claim 1, wherein a top surface of the base body protrudes upwards to form a fixing portion, a bottom of the fixed plate defines a fixing groove, the fixing portion of the side-compression block is fixed in the fixing groove of the fixed plate to make the base body and the securing portion locate under the fixed plate.

6. The injection mold as claimed in claim 1, wherein the top surface of the movable plate further defines a receiving groove apart from the securing groove, the guiding hole further penetrates through a bottom of the sliding plate, the lower end of the angular pin passes through the guiding hole to make the distal end of the angular pin received in the receiving groove when the injection mold is at the mold-closing position.
